(19) United States
(12) Patent Application Publication
(10) Pub. No.: US 2014/0305187 A1
(43) Pub. Date: Oct. 16, 2014

(54) TEST DEVICE FOR SIMULATING MOTOR VEHICLE CRASHES AND METHOD FOR OPERATING A TEST DEVICE

(71) Applicant: ILLINOIS TOOL WORKS INC., Glenview, IL (US)

(72) Inventors: Dipl.-Ing. Josef Beran, Rossdorf (DE); Thomas Probst, Gross-Umstadt (DE)

(21) Appl. No.: 14/358,749

(22) PCT Filed: Nov. 15, 2012
(86) PCT No.: PCT/US2012/065164

§ 371 Date: May 16, 2014

(30) Foreign Application Priority Data
Nov. 17, 2011 (DE) 10 2011 086 581.0

(51) Int. Cl. G01N 3/307

(52) U.S. Cl. CPC G01N 3/307
USPC 73/12.07

(57) ABSTRACT

The description relates to a method for operating a test device and to a test device for simulating motor vehicle crashes. The test device has a carriage arrangement which is arranged so as to be displaceable along a rail arrangement; a test setup which is arranged on the carriage arrangement and has at least one motor vehicle component to be tested; and an acceleration unit by means of which a force can be transmitted to the carriage arrangement in order to accelerate the carriage arrangement. The acceleration unit has a hydraulic drive cylinder with a piston and a piston rod which is connected to the carriage arrangement. At least one measuring pickup is provided for sensing a pressure which acts in the piston-side region and/or in the piston-rod-side region of the drive cylinder.

The invention relates to a test device for simulating motor vehicle crashes according to the preamble of patent claim 1, and to a method for operating a test device.

Accordingly, the invention relates to a test device for simulating motor vehicle crashes, comprising a carriage arrangement which is arranged so as to be displaceable along a rail arrangement, a test setup which is arranged on the carriage arrangement and on which is arranged or can be attached at least one motor vehicle component to be tested, and comprising an acceleration unit by means of which a force can be transmitted to the carriage arrangement in order to accelerate the carriage arrangement, wherein the acceleration unit has a hydraulic drive cylinder with a piston and a piston rod which is connected to the carriage arrangement.

Such a test device, which is also referred to in the specialist field as a servo-hydraulic catapult system, is generally known in terms of its principle from vehicle engineering and serves to cope with the ever shorter development times in automobile construction and the requirements for greater passive safety. With such a test device, inverse crash tests can be carried out. In such tests, the deceleration forces which can occur in normal operation or in the case of a crash do not act on the motor vehicle components to be examined. Instead, in inverse crash tests the acceleration forces which correspond to the deceleration forces which can occur are applied to the motor vehicle components which are to be examined.

As a rule, in this context the vehicle components which are to be examined, such as seats, steering columns and steering wheels, windshields, dashboards, seatbelts and their attachment means, airbag systems and other components, are accelerated in a controlled fashion in a reinforced vehicle body, referred to as the tank, on a carriage, corresponding to the various accident situations, and the fracture behavior or component reliability is examined. In conventional test devices, the carriage is accelerated using, for example, a pushrod which is part of the acceleration unit. In particular, it is known to move the pushrod hydraulically out of a cylinder tube of a drive cylinder in accordance with a real deceleration curve. In order to be able to simulate the real deceleration curve, it is attempted here to control the hydraulic loading of the pushrod by means of a hydraulic valve.

For example it is known that the drive cylinder is controlled by means of a four-stage servovalve which is connected to a piston storage unit. Such a servo-hydraulic catapult system is known, for example, from a work's periodical RIQ, issue 11998, pages 2 to 4 of Mannesmann-Rexroth. However, owing to the large acceleration which is necessary the hydraulic valve must have an extremely high flow rate and be able to react very quickly. In this context, multiple calibration attempts must be carried out in order to achieve adaptation to the real deceleration curve since such a hydraulic valve cannot be controlled within the test time of at maximum approximately 100 milliseconds. This conventional method is therefore comparatively costly.

Owing to this problem, the invention is based on the object of developing a test device for simulating motor vehicle crashes of the type mentioned in the introduction as well as a method for operating such a test device in such a way that a simulation of accident situations can be improved in a way which is easy to implement but nevertheless reproducible. In particular, a test device with a hydraulic drive cylinder is to be specified with which, in comparison with conventional test devices, the reproducibility of the tests and the simulation accuracy of the tests can be improved, and the number of necessary iteration steps can be reduced.

With respect to the test device, this object is achieved according to the invention in that at least one measuring pickup is provided for sensing a pressure which acts in the piston-side region of the drive cylinder and/or the pressure which acts in the piston-rod-side region of the drive cylinder, and in that a control device is provided which is configured to set a quantity of hydraulic fluid which is fed into the piston-side region or the piston-rod-side region of the drive cylinder, or discharged therefrom, per time unit, as a function of the pressure sensed in the drive cylinder, in such a way that an acceleration force which is transmitted to the carriage arrangement assumes a value which is defined or can be defined in advance.

In one preferred implementation of the solution according to the invention there is provision here that a first measuring pickup is provided for sensing the pressure which acts in the piston-side region of the drive cylinder, and a second measuring pickup is provided for sensing the pressure which acts in the piston-rod-side region of the drive cylinder, wherein the control device is configured to set the quantity of hydraulic fluid which is fed into the piston-side region of the drive cylinder per time unit, in such a way that the difference between the pressure which acts in the piston-side region and the pressure which acts in the piston-rod-side region assumes a value which is defined or can be defined in advance.

It is conceivable here that the acceleration unit has a hydraulic drive cylinder with a piston and a piston rod which is connected to the carriage arrangement which is to be accelerated, wherein quickly reacting control valves, for example a 2-control edge valve or a 1-control edge valve are provided by means of which hydraulic fluid can be applied to the drive cylinder. In the case of a 2-edge valve design, a pressure control edge which is connected to the piston-side region communicates fluidically with a high-pressure fluid reservoir, wherein a second return flow control edge of the piston-side region communicates fluidically with a pressureless return flow line.

In the case of a 1-edge valve design, the pressure control edge brings about fluidic communication of the high-pressure fluid reservoir with the piston-side region, wherein the rod-side region communicates fluidically directly with the high pressure or a low-pressure fluid reservoir. The control device is configured here to set the quantity of hydraulic fluid which is fed to the drive cylinder per time unit in such a way that the acceleration force which is transmitted to the carriage arrangement assumes a value which is defined or can be defined in advance. The high-pressure fluid reservoir makes available a hydraulic fluid to which high pressure can be applied. In the case of the 1-edge design, the low-pressure fluid reservoir takes up the quantity of fluid which accumulates in the rod-side region in the piston movement.

The fluid which is subjected to high pressure flows via the pressure control edge to the piston-side region of the drive cylinder, wherein, depending on the design, the rod-side region is connected to the low-pressure reservoir or the high-pressure reservoir. A force is applied to the carriage arrangement with the resulting pressures in the two cylinder chambers via the piston face and the piston rod, and as a result the carriage arrangement is accelerated.

In a further implementation of the solution according to the invention there is provision here that a first measuring pickup is provided for sensing the pressure which acts in the piston-side region of the drive cylinder, and a second measuring pickup is provided for sensing the pressure which acts in the piston-rod-side region of the drive cylinder, wherein the control device is configured to set the quantity of hydraulic fluid which is fed into the piston-rod-side region of the drive cylinder, or discharged therefrom, per time unit, in such a way that the difference between the pressure which acts in the piston-side region and the pressure which acts in the piston-rod-side region assumes a value which is defined or can be defined in advance.

It is conceivable here that the acceleration unit has a hydraulic drive cylinder with a piston and a piston rod which is connected to the carriage arrangement which is to be accelerated, wherein a first valve is provided via which hydraulic fluid can be applied to the piston-side region of the drive cylinder, and wherein in addition a second valve is provided via which hydraulic fluid can be applied to the piston-rod-side region of the drive cylinder. The control device is configured here to set the quantity of hydraulic fluid which is fed into the piston-rod-side region of the drive cylinder, or discharged therefrom, per time unit in such a way that the acceleration force which is transmitted to the carriage arrangement assumes a value which is defined or can be defined in advance. In particular, the first valve serves to connect the piston-side region of the drive cylinder to a fluid reservoir where necessary. The high-pressure fluid reservoir makes available a hydraulic fluid which is subjected to high pressure. The second valve also serves to connect, when necessary, the piston-rod-side region of the drive cylinder to a second high-pressure fluid reservoir or to a pressureless fluid reservoir. The fluid reservoir which is assigned to the second valve makes available a hydraulic fluid whose pressure is higher than the pressure of the hydraulic fluid which is made available with the fluid reservoir which is connected to the first valve.

The fluid which is subjected to high pressure is fed via the first valve to the piston-side region of the drive cylinder, with the result that a force is applied to the carriage arrangement via the piston face and the piston rod, as a result of which the carriage arrangement is accelerated. Via the second valve, fluid can flow out of the piston-rod-side region of the drive cylinder in a defined fashion and/or fluid can flow into the piston-rod-side region of the drive cylinder in a defined fashion, and in this way influence the pressure and the resulting acceleration.

The acceleration unit preferably has a first and a second measuring pickup for sensing the pressure prevailing in the piston-side region of the drive cylinder, on the one hand, and the pressure prevailing in the piston-rod-side region of the drive cylinder, on the other.

In one preferred implementation of the test device according to the invention, the control device is connected via a setpoint-variable input to an open-loop control device in order to obtain a predefined acceleration profile as a setpoint variable. The control input of the control device is connected via a subtractor to the first and second measuring transducers in a signal-transmitting connection in order to obtain the difference between the pressures from the interior of the drive cylinder as a controlled variable, which are linked to the acceleration via the geometry of the piston, the structure of the test device and the mass of the carriage arrangement. The control device has a signal-transmitting connection by its control output to the valve in order to regulate as a manipulated variable the flow rate of the valve in such a way that the resulting acceleration of the carriage arrangement follows the acceleration profile.

In an alternative embodiment of the test device according to the invention, just a single measuring pickup is provided for sensing the pressure prevailing in the piston-side region of the drive cylinder or for sensing the pressure prevailing in the piston-rod-side region of the drive cylinder, wherein only the measuring signal of this measuring pickup is directly connected as a controlled variable to the control input of the control device via a signal line.

With respect to the method, the object on which the invention is based is solved according to the invention by means of the method steps specified below:
1. a pressure acting in the piston-side region of the drive cylinder is measured using a first measuring pickup;
2. a pressure acting in the piston-rod-side region of the drive cylinder is measured using a second measuring pickup; and
3. a quantity of hydraulic fluid which is fed to the piston-side region of the drive cylinder per time unit is set in such a way that the difference between the pressure acting in the piston-side region of the drive cylinder and the pressure acting in the piston-rod-side region of the drive cylinder assumes a value which is defined in advance.

Alternatively, the following method steps can occur instead of step 3:
a quantity of hydraulic fluid is fed to the piston-side region of the drive cylinder per time unit, with the result that a constant pressure level is set, and
a quantity of hydraulic fluid which is fed into the piston-rod-side region of the drive cylinder, or discharged therefrom, per time unit is set in such a way that the difference between the pressure acting in the piston-side region of the drive cylinder and the pressure acting in the piston-rod-side region of the drive cylinder assumes the value which is defined in advance.

The advantages which can be achieved with the solution according to the invention are obvious. Accordingly, the test device according to the invention is characterized in that as a result of the active control of the manipulated variable the resulting acceleration of the carriage arrangement follows the predefined acceleration profile more precisely. Since the manipulated variable is the flow rate of the hydraulic fluid, the control takes place without wear and with a high degree of reproducibility.

In the text which follows, an exemplary embodiment of the test device according to the invention will be described in more detail with reference to the appended drawing, in which:

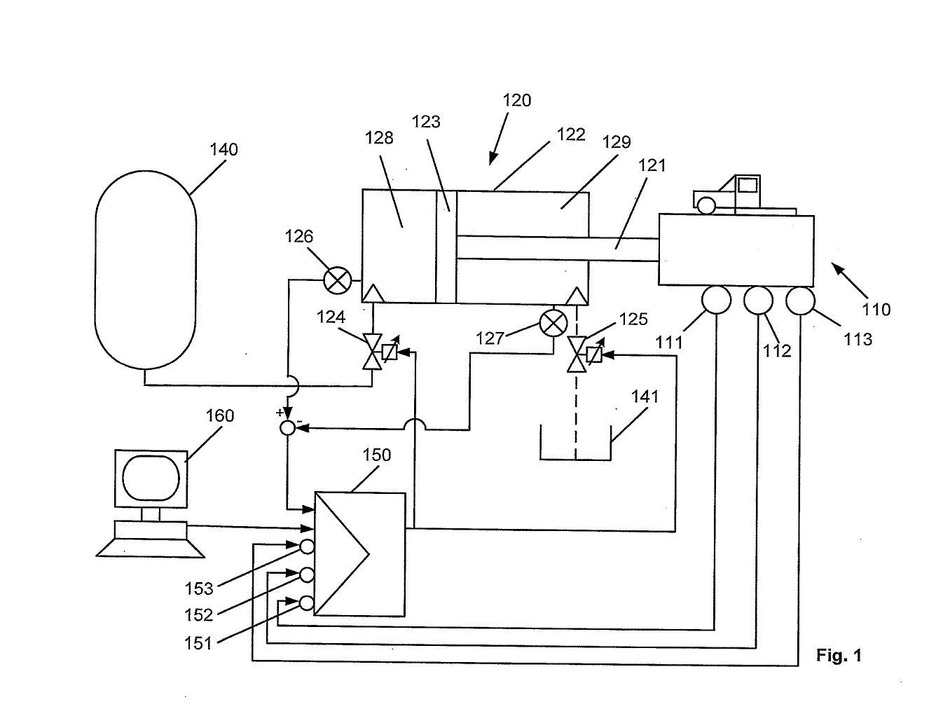

FIG. 1 shows a signal flowchart of an exemplary 2-control edge embodiment of the test device according to the invention;

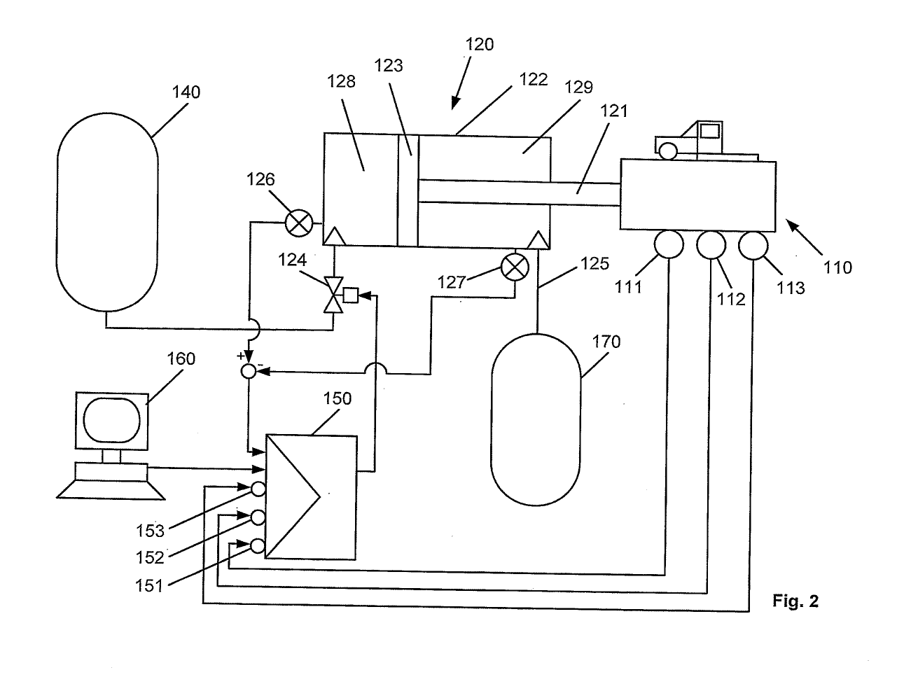

FIG. 2 shows a signal flowchart of an exemplary 1-control edge embodiment of the test device according to the invention;

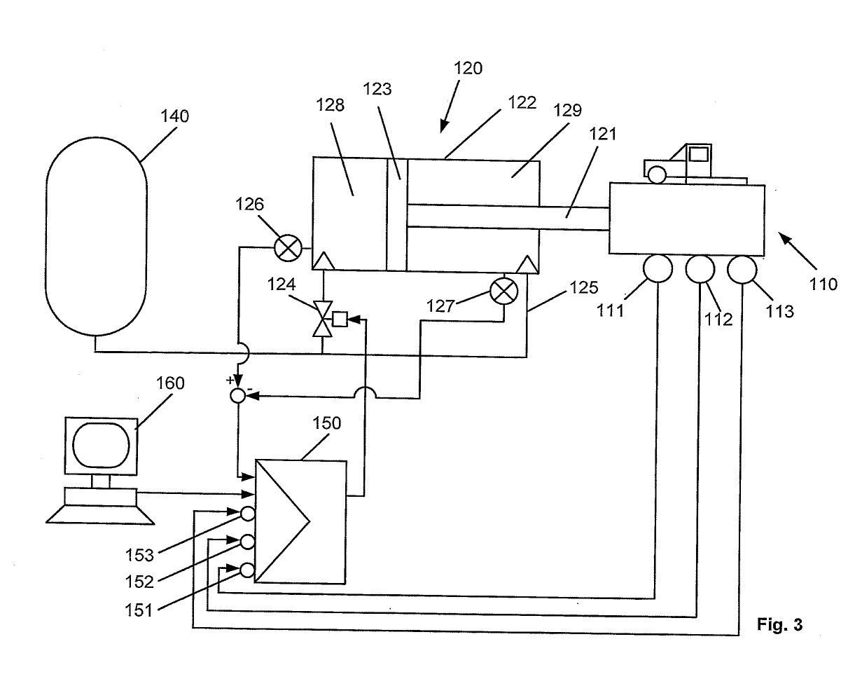

FIG. 3 shows a signal flowchart of a further exemplary 1-control edge embodiment of the test device according to the invention; and

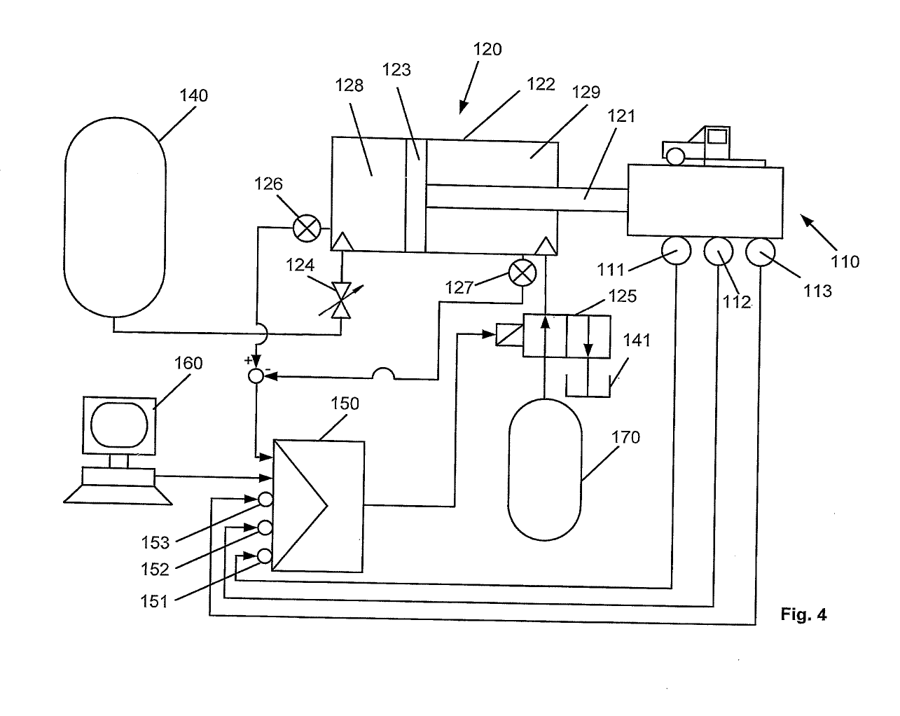

FIG. 4 shows a signal flowchart of a further exemplary embodiment of the invention with a 2-way valve.

FIG. 1 is a schematic view of a signal flowchart of an exemplary embodiment of the test device 100 according to the invention. As illustrated, the test device 100 has a carriage arrangement 110 and an acceleration unit 120. The carriage arrangement 110 and the acceleration unit 120 are connected by means of a force-transmitting device 121. In the embodiment shown, the force-transmitting device 121 is a pushrod or piston rod. A test object, for example a motor vehicle or components thereof, can be arranged on the carriage arrangement 110.

The acceleration unit 120 has a hydraulic drive cylinder 122 with a piston 123 and a 2-edge valve (pressure control edge 124, return flow control edge 125). The piston 123, together with the piston rod 121 which is connected thereto, can be displaced axially along the axis of the drive cylinder 122 and separates two cylinder regions, the piston-side cylinder region 128 and the piston-rod-side cylinder region 129 from one another in a fluid-tight fashion.

In particular, in the embodiment of the test device 100 according to the invention which is illustrated in FIG. 1 there is provision that the drive cylinder 122 is embodied as a double-acting cylinder, wherein the pressure control edge 124 (already mentioned), by means of which hydraulic fluid can be applied to the piston-side region 128 of the drive cylinder 122, is provided. In addition, the second synchronously opened return flow control edge 125 (also already mentioned), by means of which the piston-rod-side region 129 of the drive cylinder 122 is fluidically connected to the return flow line, is provided.

In the embodiment of the test device 100 according to the invention which is schematically illustrated in FIG. 1, the pressure control edge 124 is fluidically connected by its side (not connected to the piston-side region 128 of the drive cylinder 122) to a first high-pressure fluid reservoir 140. The pressure of the fluid (hydraulic fluid) which is made available with the first fluid reservoir 140 is of the same magnitude as, and preferably greater than, the pressure P1 in the piston-side region 128 of the drive cylinder 122. The first fluid reservoir 140 may be, for example, a piston storage unit. On the other hand, the return flow control edge 125 is fluidically connected, by its side which is not connected to the piston-rod-side region 129 of the drive cylinder 122, to the return flow reservoir 141. The pressure of the fluid (hydraulic fluid) which is made available with the second fluid reservoir 141 is lower than in the piston-rod-side region.

Accordingly, a hydraulic fluid which is under high pressure can be fed to the piston-side region 128 of the drive cylinder 122 via the pressure control edge 124, with the result that the pressure P1 prevailing in the piston-side region 128 of the drive cylinder 122 can be increased, and a pressure force acting on the piston 123 and the piston rod 121 can be transmitted, after having been reduced by the low opposing force in the rod-side region, to the carriage arrangement 110. In this way, the carriage arrangement can be accelerated.

The pressure control edge 124 and return flow control edge 125 can optionally also be implemented in separate valves.

In particular, the pressure force acting on the piston rod 121 is determined by the difference between the pressure P1 prevailing in the piston-side region 128 of the drive cylinder 122 and the pressure P2 prevailing in the piston-rod-side region 129 of the drive cylinder 122. In addition, the active area which is present in the piston-side region 128 on the piston 123, and the active area which is present in the piston-rod-side region 129 on the piston 123 influence the pressure force which is acting on the piston rod 121.

As already indicated, fluid, for example hydraulic fluid, can flow out of the piston-rod-side region 129 of the drive cylinder 122 via the second valve 125. In this way, the pressure P2 which occurs in the piston-rod-side region 129 and the resulting acceleration can be influenced.

As illustrated in FIG. 1, the illustrated embodiment of the test device 100 according to the invention also has measuring pickups 126, 127 for sensing the pressure P1 in the piston-side region 128 of the drive cylinder 122, on the one hand, and for sensing the pressure P2 in the piston-rod-side region 129 of the drive cylinder 122, on the other.

In addition, a control device 150 is provided which, in the embodiment illustrated in FIG. 1, is connected to a control unit 160, for example to a PC, via a signal-transmitting connection. A setpoint variable, which can be defined in advance and input, for example, manually into the control unit 160, is transmitted to the control device 150 from the control unit 160 via the signal-transmitting connection. The setpoint variable can be a predefinable acceleration value or else also a predefined acceleration profile (i.e. a predefined variation of the acceleration over time).

The control device 150 is configured to adjust a controlled variable according to the setpoint variable. In one preferred embodiment of the test device 100 according to the invention, the controlled variable is the difference between the pressure P1 which acts in the piston-side region 128 and the pressure P2 which acts in the piston-rod-side region 129. The difference pressure according to general laws of hydraulics and of physics is linked to the acceleration via the geometry of the piston 123, the structure of the test device 100 and the mass of the carriage arrangement 110. In particular it can be assumed that the difference pressure is proportional to an acceleration force which is transmitted to the carriage arrangement 110 via the acceleration unit 120.

The control device 150 is configured to change the flow rate of the 2-edge valve (pressure control edge 124, return flow control edge 125) as a manipulated variable and therefore influence the pressures P1, P2 in the drive cylinder 122 by means of a change in the quantity of fluid which is fed to the piston-side region 128, and discharged in the rod-side region 129, per time unit.

In an alternative embodiment of the test device 100 according to the invention, the control device 150 is configured to sense only the pressure P1 in the piston-side region 128 of the drive cylinder 122 of just one measuring pickup 127 and to evaluate it as a controlled variable.

The method for inventively simulating motor vehicle crashes has the following steps:

The control unit 160 outputs a setpoint variable to the control device 150 via the signal-transmitting connection. The setpoint variable corresponds to a desired acceleration of the carriage arrangement 110 at the respective time. In its chronological profile, the setpoint variable corresponds to the desired acceleration profile. The difference between the signals of the two pressure measuring pickups 126 and 127 is present as a controlled variable at the control device 150. The acceleration of the carriage arrangement 110 is linked to the controlled variable according to general laws of hydraulics and physics via the geometry of the piston 123 and the mass of the carriage arrangement 110.

The control device 150 controls as the manipulated variable the flow rate of the 2-edge valve (pressure control edge 124, return flow control edge 125) in such a way that the resulting acceleration of the carriage arrangement 110 follows the desired acceleration profile. For this purpose, the control device opens the 2-edge valve to such an extent that in each case so much pressurized fluid flows into the first cylinder region 128 from the pressure reservoir 140 and flows away from the region 129 to the pressureless reservoir 141 that the force applied to the piston by the pressure difference between the first and second cylinder regions 128, 129 brings about the desired acceleration of the carriage arrangement 110 by means of the force-transmitting device.

In various embodiments of the test device 100, inter alia proportional (P) controllers, proportional integral (PI) controllers or proportional integral differential (PID) controllers can be used as a control device 150.

The test device 100 can have further braking means for braking the carriage arrangement 110 again subsequent to the test phase. Furthermore, it is possible to configure the connection between the carriage arrangement 110 and the force-transmitting unit 121 in such a way that after the acceleration phase the carriage arrangement 110 becomes detached from the force-transmitting unit 121 by the piston 123, and is braked with suitable braking means independently of the piston 123 and the force-transmitting unit 121.

The embodiment with a 1-control edge valve is illustrated by way of example in FIG. 2. In the embodiment of the inventive test device 100 which is illustrated schematically in FIG. 2, the control edge 124 is fluidically connected by its side, which is not connected to the piston-side region 128 of the drive cylinder 122, to a first high-pressure fluid reservoir 140. The pressure of the fluid (hydraulic fluid) which is made available with the first fluid reservoir 140 is of the same magnitude as, and preferably larger than, the pressure P1 in the piston-side region 128 of the drive cylinder 122. The first fluid reservoir 140 may be, for example, a piston storage unit.

On the other hand, the piston-rod-side region 129 of the drive cylinder 122 is fluidically connected to the return flow reservoir 170. The pressure of the fluid (hydraulic fluid) which is made available with the second fluid reservoir 170 is lower than in the piston-rod-side region.

A hydraulic fluid which is under high pressure can accordingly be fed to the piston-side region 128 of the drive cylinder 122 via the control edge 124, with the result that the pressure P1 prevailing in the piston-side region 128 of the drive cylinder 122 can be increased, and a pressure force acting on the piston 123 and the piston rod 121 can be transmitted, after having been reduced by the low opposing force in the rod-side region, to the carriage arrangement 110. In this way, the carriage arrangement 110 can be accelerated. In the text which follows, the device described in FIG. 2 corresponds to the embodiment already described in relation to FIG. 1.

Accordingly, the method with the device from FIG. 2 differs in that the control device 150 as a manipulated variable the flow rate of the 1-edge valve (control edge 124) in such a way that the resulting acceleration of the carriage arrangement 110 follows the desired acceleration profile.

FIG. 3 illustrates by way of example a further embodiment with a 1-control edge valve. In the embodiment of the inventive test device 100 which is illustrated schematically in FIG. 3, the control edge 124 is fluidically connected by its side, which is not connected to the piston-side region 128 of the drive cylinder 122, to a first high-pressure fluid reservoir 140. The pressure of the fluid (hydraulic fluid) which is made available with the first fluid reservoir 140 is of the same magnitude as, and preferably larger than, the pressure P1 in the piston-side region 128 of the drive cylinder 122. The first fluid reservoir 140 may be, for example, a piston storage unit.

The piston-rod-side region 129 of the drive cylinder 122 is also fluidically connected to the fluid reservoir 140. Since the active area of the piston in the piston-rod-side region is reduced by a value equal to the cross section of the piston rod, in the acceleration phase the opposing force on the piston rod side is smaller than or equal to the acceleration force on the piston rod side. As a result, the fluid from the piston-rod-side region is capable of flowing back counter to the pressure of the fluid reservoir 140.

Accordingly, a hydraulic fluid which is under high pressure can be fed to the piston-side region 128 of the drive cylinder 122 via the control edge 124, with the result that the pressure P1 prevailing in the piston-side region 128 of the drive cylinder 122 can be increased, and a pressure force which acts on the piston 123 and the piston rod 121 can be transmitted, after having been reduced by the low opposing force in the rod-side region, to the carriage arrangement 110. In this way, the carriage arrangement 110 can be accelerated.

In the text which follows, the device described in FIG. 3 corresponds to the embodiment described in relation to FIG. 2.

FIG. 4 shows a schematic signal flowchart for a further exemplary embodiment of the test device 100 according to the invention. The same parts as in FIGS. 1 to 3 are denoted by the same reference symbols.

In particular, in the embodiment of the inventive test device 100 which is illustrated in FIG. 4 there is provision, as in the preceding embodiments, that the drive cylinder 122 is embodied as a double-acting cylinder, wherein a first valve 124 is provided via which hydraulic fluid can be applied to the piston-side region 128 of the drive cylinder 122. In addition, the second valve 125 is provided, via which hydraulic fluid can be applied to the piston-rod-side region 129 of the drive cylinder 122.

In the embodiment of the inventive test device 100 which is illustrated schematically in FIG. 4, the first valve 124 is fluidically connected by its side, which is not connected to the piston-side region 128 of the drive cylinder 122, to a first fluid reservoir 140. The first fluid reservoir 140 can be, for example, a piston storage unit. On the other hand, the second valve 125 is fluidically connected, by its side which is not connected to the piston-rod-side region 129 of the drive cylinder 122, either to a second pressureless fluid reservoir 141 or a high-pressure fluid reservoir 170, depending on the actuation signal.

Accordingly, a hydraulic fluid which is under high pressure can be fed to the piston-side region 128 of the drive cylinder 122 via the first valve 124, with the result that the pressure P1 which prevails in the piston-side region 128 of the drive cylinder 122 can be increased, and a pressure force which acts on the piston 123 and the piston rod 121 can be transmitted to the carriage arrangement 110. In this way, the carriage arrangement 110 can be accelerated.

In particular, the pressure force acting on the piston rod 121 is determined by the difference between the pressure P1 prevailing in the piston-side region 128 of the drive cylinder 122 and the pressure P2 prevailing in the piston-rod-side region 129 of the drive cylinder 122. In addition, the active area, which is present in the piston-side region 128, on the piston 123 and the active area, which is present in the piston-rod-side region 129, on the piston 123 influence the pressure force which acts on the piston rod 121.

As already indicated, fluid, such as for example hydraulic fluid, can flow in and out of the piston-rod-side region 129 of the drive cylinder 122 via the second valve 125. In this way, the pressure P2 which occurs in the piston-rod-side region 129 and the resulting acceleration can be decisively influenced.

As illustrated in FIG. 4, the illustrated embodiment of the test device 100 according to the invention also has measuring pickups 126, 127 for sensing the pressure P1 in the piston-side region 128 of the drive cylinder 122, on the one hand, and for sensing the pressure P2 in the piston-rod-side region 129 of the drive cylinder 122, on the other.

In addition, a control device 150 is also provided which, in the embodiment illustrated in FIG. 4, is connected to a control unit 160, such as for example to a PC, via a signal-transmitting connection. Via the signal-transmitting connection, a setpoint variable which can be defined in advance and can, for example, be input manually into the control unit 160 is transmitted from the control unit 160 to the control device 150. The setpoint variable can be a predefined acceleration value or else also a predefined acceleration profile (i.e. a predefined variation of the acceleration over time).

The control device 150 is configured to adjust a controlled variable according to the setpoint variable. In one preferred embodiment of the test device 100 according to the invention, the controlled variable is the difference between the pressure P1 acting in the piston-side region 128 and the pressure P2 acting in the piston-rod-side region 129. According to general laws of hydraulics and of physics, the difference pressure is linked to the acceleration via the geometry of the piston 123, the structure of the test device 100 and the mass of the carriage arrangement 110. In particular it can be assumed that the difference pressure is proportional to an acceleration force which is transmitted to the carriage arrangement 110 via the acceleration unit 120.

The control device 150 is configured to change, as a manipulated variable, the flow rate through the second valve 125 and therefore influence the pressure P2 in the piston-rod-side region 129 of the drive cylinder 122 by changing the quantity of fluid which is fed into the piston-rod-side region 129, or discharged therefrom, per time unit.

In an alternative embodiment of the test device 100 according to the invention, the control device 150 is configured to sense only the pressure P2 in the piston-rod-side region 129 of the drive cylinder 122 from just one measuring pickup 127 and to evaluate it as a controlled variable.

The method for inventively simulating motor vehicle crashes has the following steps:

The control unit 160 outputs a setpoint variable to the control device 150 via the signal-transmitting connection. The setpoint variable corresponds to a desired acceleration of the carriage arrangement 110 at the respective time. In its chronological profile, the setpoint variable corresponds to the desired acceleration profile. The difference between the signals of the two pressure measuring pickups 126 and 127 is present as a controlled variable at the control device 150. The acceleration of the carriage arrangement 110 is linked to the controlled variable according to general laws of hydraulics and of physics via the geometry of the piston 123 and the mass of the carriage arrangement 110.

A constant quantity of hydraulic fluid is fed to the piston-side region 128 of the drive cylinder 122 per time unit. Feeding a constant pressure into the piston-side region 128 of the drive cylinder 122 gives rise to a constant acceleration force which acts on the carriage arrangement 110. A dynamic acceleration force is formed by dynamically changing the pressure in the piston-rod-side region 129 of the drive cylinder 122.

In particular, the control device 150 controls, as a manipulated variable, the flow rate of the second valve 125 in such a way that the resulting acceleration of the carriage arrangement 110 follows the desired acceleration profile. For this purpose, the control device opens the valve 125 to such an extent that in each case so much pressurized fluid flows out of the high-pressure reservoir 170 into the piston-rod-side region 129 of the drive cylinder 122 or flows into the pressureless reservoir via the valve 125 that the force applied to the piston 123 by the pressure difference between the piston-side region 128 and the piston-rod-side region 129 brings about the desired acceleration of the carriage arrangement 110 by means of the force-transmitting device 121.

In various embodiments of the test device 100, for example proportional (P) controllers, proportional integral (P1) controllers or proportional integral differential (PID) controllers can be used as the control device 150. The control device 150 can have further braking means for braking the carriage arrangement 110 again subsequent to the test phase. Furthermore, it is possible to configure the connection between the carriage arrangement 110 and the force-transmitting unit 121 in such a way that after the acceleration phase the carriage arrangement 110 becomes detached from the force-transmitting unit 121 by the piston 123, and is braked with suitable braking means independently of the piston 123 and of the force-transmitting unit 121.

The invention is not restricted to the embodiments of the test device 100 which are described by way of example with reference to FIG. 1 to FIG. 4, but instead said invention results from a combination of all the features and advantages described herein.

1. A test device for simulating motor vehicle crashes, wherein the test device has the following:
a carriage arrangement which is arranged so as to be displaceable along a rail arrangement;
a test setup which is arranged on the carriage arrangement and has at least one motor vehicle component to be tested; and
an acceleration unit by means of which a force can be transmitted to the carriage arrangement in order to accelerate the carriage arrangement, wherein the acceleration unit has a hydraulic drive cylinder with a piston and a piston rod which is connected to the carriage arrangement,
characterized
in that at least one measuring pickup is provided for sensing a pressure which acts in the piston-side region of the drive cylinder and/or the pressure which acts in the piston-rod-side region of the drive cylinder, and in that a control device is provided which is configured to set a quantity of hydraulic fluid which is fed into the piston-side region or the piston-rod-side region of the drive cylinder, or discharged therefrom, per time unit, as a function of the pressure sensed in the drive cylinder, in such a way that an acceleration force which is transmitted to the carriage arrangement assumes a value which is defined or can be defined in advance.

2. The test device as claimed in claim 1,
wherein a first measuring pickup is provided for sensing the pressure which acts in the piston-side region of the drive cylinder, and wherein a second measuring pickup is provided for sensing the pressure which acts in the piston-rod-side region of the drive cylinder; and
wherein the control device is configured to set the quantity of hydraulic fluid which is fed into the piston-side region or the piston-rod-side region of the drive cylinder, or discharged therefrom, per time unit, in such a way that the difference between the pressure which acts in the piston-side region and the pressure which acts in the piston-rod-side region assumes a value which is defined or can be defined in advance.

3. The test device as claimed in claim 2,
wherein the difference between the pressure which acts in the piston-side region and the pressure which acts in the piston-rod-side region is proportional to an acceleration force transmitted to the carriage arrangement via the acceleration unit; and wherein the value, which is defined or can be defined in advance, of the difference between the pressure which acts in the piston-side region and the pressure which acts in the piston-rod-side region corresponds to a setpoint value, which is defined or can be defined in advance, of an acceleration force.

4. The test device as claimed in claim 1, wherein the drive cylinder is embodied as a double-acting cylinder, wherein a first valve is provided, by means of which hydraulic fluid can be applied to the piston-side region of the drive cylinder, wherein the pressure which acts in the piston-side region of the drive cylinder can be set by actuating the first valve, and wherein a second valve is provided, by means of which the hydraulic fluid can be applied to the piston-rod-side region of the drive cylinder, wherein the pressure which acts in the piston-rod-side region of the drive cylinder can be set by actuating the second valve; and wherein the control device is also configured to set the quantity of hydraulic fluid which is fed into the piston-rod-side region of the drive cylinder, or discharged therefrom, per time unit in such a way that the acceleration force which is transmitted to the carriage arrangement assumes a value which is defined or can be defined in advance.

5. The test device as claimed in claim 4,
wherein the control device is configured to adjust the acceleration of the carriage arrangement according to a predefined acceleration profile using the pressure in the piston-rod-side region of the drive cylinder as control variables, wherein the flow rate through the second valve is the manipulated variable of the control device.

6. The test device as claimed in claim 4, wherein in addition an open-loop control device is provided which controls the flow rate through the first valve according to a predefined value.

7. The test device as claimed in claim 6,
wherein in addition a further control device is provided for adjusting the pressure in the piston-side region of the drive cylinder, connected to the first valve, according to a predefined constant value, wherein the flow rate through the first valve is the manipulated variable of the further control device.

8. The test device as claimed in claim 1, wherein the control device is configured to set a quantity of hydraulic fluid, which is fed into the piston-rod-side region of the drive cylinder, or discharged therefrom, per time unit as a function of the pressure sensed in the drive cylinder, in such a way that at any time an acceleration force which is transmitted to the carriage arrangement assumes a value which is defined or can be defined in advance.

9. The test device as claimed in claim 1, wherein, in order to control the acceleration of the carriage arrangement according to a predefined acceleration profile, the control device has a P controller, PI controller or PID controller, wherein the pressure which acts in the piston-side region of the drive cylinder and/or the pressure which acts in the piston-rod-side region of the drive cylinder are/is the control variable.

10. A method for operating a test device for simulating motor vehicle crashes, which has an acceleration unit by means of which, in order to accelerate a carriage arrangement, a force can be transmitted to the carriage arrangement, wherein the acceleration unit has a hydraulic drive cylinder with a piston and a piston rod which is connected to the carriage arrangement, wherein the method has the following method steps:
a pressure which acts in the piston-side region of the drive cylinder is measured using a first measuring pickup;
a pressure which acts in the piston-rod-side region of the drive cylinder is measured using a second measuring pickup;
a pressurized hydraulic fluid is applied to the piston-side region of the drive cylinder via a fluid connection with a constant cross section, and a quantity of hydraulic fluid which is fed into the piston-rod-side region of the drive cylinder, or discharged therefrom, per time unit is set in such a way that the difference between the pressure which acts in the piston-side region of the drive cylinder and the pressure which acts in the piston-rod-side region of the drive cylinder assumes the value which is defined in advance; or
a quantity of hydraulic fluid which is fed into the piston-side region of the drive cylinder per time unit is set in such a way that the pressure which acts in the piston-side region of the drive cylinder assumes a value which is defined in advance; and
a quantity of hydraulic fluid which is fed into the piston-rod-side region of the drive cylinder, or discharged therefrom, per time unit is set in such a way that the difference between the pressure which acts in the piston-side region of the drive cylinder and the pressure which acts in the piston-rod-side region of the drive cylinder assumes the value which is defined in advance; or
a quantity of hydraulic fluid which is fed into the piston-side region of the drive cylinder per time unit is set in such a way that the difference between the pressure which acts in the piston-side region of the drive cylinder and the pressure which acts in the piston-rod-side region of the drive cylinder assumes a value which is defined in advance.

11. The method as claimed in claim 10,
wherein the difference between the pressure which acts in the piston-side region and the pressure which acts in the piston-rod-side region is proportional to an acceleration force which is transmitted to the carriage arrangement via the acceleration unit; and
wherein the value, which is defined or can be defined in advance, of the difference between the pressure which acts in the piston-side region and the pressure which acts in the piston-rod-side region corresponds to a setpoint value, which is defined or can be defined in advance, of an acceleration force.
